(19) United States
(12) Patent Application Publication
(10) Pub. No.: US 2007/0225835 A1
(43) Pub. Date: Sep. 27, 2007

(54) Computer method and apparatus for adaptive model predictive control

(76) Inventor: Yucai Zhu, Best (NL)

Correspondence Address: Yucai Zhu, Grensheuvel 10, Best, 5686 AG, omitted

(21) Appl. No.: 11/705,590

(22) Filed: Feb. 13, 2007

Related U.S. Application Data
(60) Provisional application No. 60/784,898, filed on Mar. 23, 2006.

(51) Int. Cl. G05B 13/02

(52) U.S. Cl. 700/44

(57) ABSTRACT

A computer method and apparatus for adaptive model predictive control (MPC) of multivariable processes is disclosed. The adaptive MPC system can perform automatic implementation for a new MPC controller, and, for an existing MPC controller, it can perform automatic maintenance when necessary. The adaptive MPC system consists of three modules: an MPC control module, an online identification module and a control monitor module. In MPC implementation, the online identification module and the MPC control module work together and perform various steps in MPC implementation automatically and efficiently. When the MPC controller is online, the control monitor module continuously monitors the MPC performance and model quality. When control performance becomes poor and considerable model degradation is detected, monitor module will start the maintenance by activating the online identification module. The identification module will re-identify the model and replace the old model. For strongly nonlinear process units, multiple models are identified and used in control.

### FIELD OF THE INVENTION

The present invention is an adaptive MPC system for controlling industrial processing units, particularly in the process industries such as refining, petrochemical, chemical, steel, food, pulp and paper and utilities. It is related to advanced process control (APC) and more specifically, to model predictive control (MPC) of industrial processes. The invention can deal with large-scale process units with many manipulated variables (MVs) and many controlled variables (CVs). The method can also be used to control complex machines and equipments.

### BACKGROUND OF THE INVENTION

Model predictive control (MPC) has become a standard technology of advanced process control (APC). It has gained its industrial position in refinery and petrochemical industries (Qin and Badgwell, 2003) and is beginning to attract interest from other process industries. Dynamic process models play a central role in MPC technology and process models are obtained mostly by means of process identification. Industrial experience has shown that the most difficult and time-consuming work in an MPC project is plant testing and model identification (Richalet, 1993). An MPC controller with a fixed model cannot work forever. Maintenance is needed when considerable process changes take place. In MPC maintenance, the main task is model re-identification.

At present, a common MPC project approach has following steps:
1) MPC controller design and benefit analysis. In this step, MVs, DVs and CVs are selected and their control requirements specified. Regulatory control loops are inspected and tunings are performed if necessary.
2) Pre-test. In this step, short step tests are performed to obtain rough estimated of process settling time and some model gains.
3) Identification test and model identification. In this step, plant test is performed. The test is often done manually, in single variable and in open loop although some automated test methods are emerging recently. Then model identification is performed using testing data in a model identification program. Both plant test and model identification are very time consuming.
4) MPC controller tuning and simulation. In this step, the identified model is used to simulate the MPC controlled system using a simulation program.
5) MPC controller commissioning. In this step, the MPC controller is commissioned by gradually turning on each MVs and CVs.
6) MPC controller maintenance. After some time of operation, the control performance degrades due to process changes. Therefore, MPC maintenance is needed to prevent the loss of benefits. The main task of maintenance is to re-identify the process model and to re-commission the MPC controller.

The biggest problem of today's conventional MPC technology that follows the above mentioned approach is its high costs. Highly skilled control engineers with many years of experience are needed to perform the steps outlined above and each step cost considerable time and effort. Different software packages are used in different steps, which is not convenient for the user. With the exception of the refining and petrochemical industry, this high cost has prevented the wide-spread application of MPC technology in most process industries. The high cost even cause problems in MPC maintenance in the refining and petrochemical industry.

Some process units show strong nonlinearity in their operation and the use of an MPC with a single linear model cannot obtain high performance for this class of processes. Examples of strongly nonlinear processes are polymer units with different grades, lubricate oil units with different grades, crude units with very different crude types and coal-fired power plants with large load variations.

### SUMMARY OF THE INVENTION

The present invention is a computer method and apparatus for an adaptive MPC system that can automatically and efficiently perform MPC implementation and maintenance, that is, steps 2) to 6) mentioned above. For strongly nonlinear processes, multiple models are identified and used in MPC control.

The adaptive MPC system consists of three modules: 1) an MPC control module (will be referred as control module), 2) an online identification module (will be referred as identification module) and 3) a control performance monitoring module (will be referred as monitor module). The three modules can perform their corresponding tasks automatically and they coordinate with each other to achieve adaptive MPC control. Adaptive MPC control means automatic MPC implementation and automatic maintenance. Assume that an MPC controller design is given. During the MPC implementation, the online identification module performs automated plant test and automatic model identification. During the plant test, when some identified models have good quality for control according to model validation and control simulation, they will be used in the MPC controller and the corresponding manipulated variables (MV) and controlled variables (CV) will be automatically turned on. The same hold for disturbance variables (DV). As the test continues, more and more models will be loaded in the MPC controller and MVs and CVs turned on. When all expected models become good and used in the MPC controller, the identification module will stop and the MPC commissioning is finished. For an online MPC controller, the monitoring module continuously monitors its performance. When the MPC monitor detects considerable control performance and model quality degradation, it will activate the online identification module and plant test and model identification will start while the MPC controller is still on. During the test and identification, poor models will be gradually replaced with the new and good ones. When all the poor models are replaced, the identification module will stop and the MPC maintenance is finished. The adaptive MPC can considerably reduce the cost MPC deployment and can maintain high control performance all the time.

For a strongly nonlinear process unit, multiple models will be identified using the identification module. Each model is a linear model or a simple nonlinear model such as Wiener model and Hammerstein model. Then, the control module will use multiple models to control the nonlinear process unit.

### BRIEF DESCRIPTION OF THE DRAWINGS

FIG. 1 shows the block diagram of a control system using a conventional MPC controller.

FIG. 2 shows the block diagram of a control system using the adaptive MPC system of this invention.

### DETAILED DESCRIPTION OF THE INVENTION

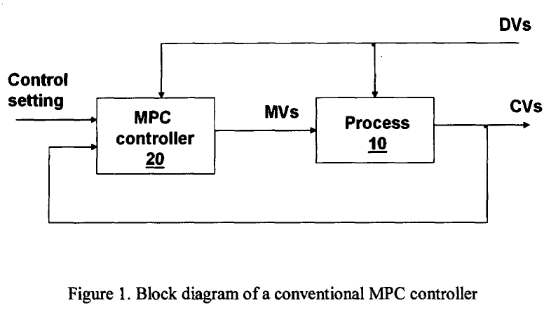

Before describing the invention, it is useful to briefly discuss a conventional MPC controller. FIG. 1 shows the general block diagram of a conventional MPC controlled system. An industrial process 10 has multiple manipulated variables (MVs), multiple controlled variables (CVs) and multiple disturbance variables (DVs). In process control, the process is considered a dynamic process and its behaviour is described by a dynamic model that relates the MVs and DVs to the CVs of the process. Note that we sometimes refer a process model to the multivariable model of the whole process; sometimes we refer a process model to a single variable model for an MV-CV pair. An MPC controller 20 is connected to the process and is used to control and optimize the process operation. The MPC controller 20 uses a dynamic process model to predict the future moves of CVs and calculates the necessary MV control actions in order to achieve desired control of the CVs. The CVs can be controlled to follow setpoints or to stain within zone limits. MV control actions will respect high/low limits and rate-of-change limits. The DVs are used in CV prediction so that feedforward control is realised. The numerical calculation of the MPC control problem is typically done using a quadratic programming (QP), an optimization technique. In FIG. 1, “Control setting” contains the MV high/low limits, MV rate-of-change limits, CV high/low limits, CV setpoints, and control tuning parameters such as weighting factors and priority ranks. See Qin and Badgwell (2003) for more detailed discussion on conventional MPC control.

The process model is typically obtained using process identification that includes plant test and model identification. In a conventional MPC project, plant test is done manually or using a test program; model identification is done using another program. When all expected models (here we mean single variable models) are obtained, they are loaded in the MPC control program, the MPC controller 20 in FIG. 1. As mentioned before, plant test and model identification is the most difficult and most time consuming in conventional MPC projects. In MPC controller maintenance, plant test and model identification must be carried out again in order to re-identify process models.

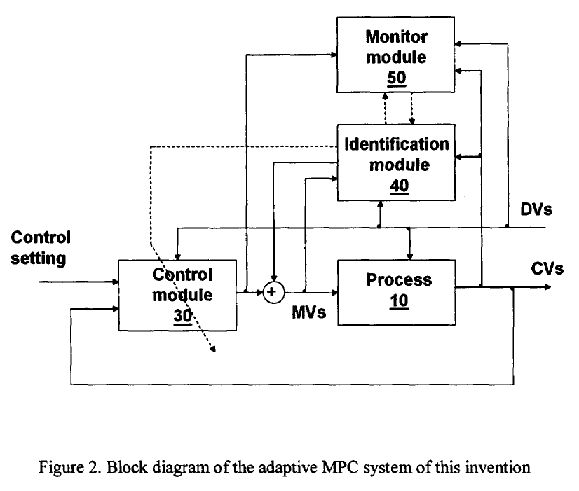

The adaptive MPC system of this invention is shown in FIG. 2. Nowadays processing units use distributed control systems (DCS) as their instrumentation and regulatory control. In the illustrations and diagrams, we will assume that the given process unit is under DCS control, although the invention can also work with other instrumentation systems, such as programmable logic control (PLC) systems, or supervisory control and data acquisition (SCADA) systems. The adaptive MPC system of this invention will be typically located in a personal computer (PC) using Microsoft Windows® operating system, although it can also be located in other kind of computers using other operating systems such as Linux and UNIX. It can also be embedded in a digital signal processor (DSP).

For a process 10, the adaptive MPC system has three modules: i) control module 30, ii) identification module 40 and iii) monitor module 50.

The control module 30 has all the basic functionalities of the conventional MPC controller 20 in FIG. 1, plus three more major functionalities that are important for automatic MPC controller commissioning and automatic maintenance: 1) automatic MPC simulation; 2) auto-tuning of controller parameters and 3) automatic switch-on of MVs and CVs. They work as follows.

Default MPC control parameters are given in the MPC design and these parameters include static and dynamic weighting factors of MVs and of CVs, as well as CV closed-loop response times. The control module only tunes dynamic weighting factors of MVs and of CVs and CV closed-loop response times which are used in dynamic optimization. The control module will simulate step responses using the model and control parameters and check the setpoint following properties of the corresponding CVs. If the simulation results show good performance, the control module will turn on the corresponding MVs and CVs. If the simulated step response is too fast, the dynamic weightings of the corresponding MVs will be increase and/or the CV closed-loop response time will be increased; if the simulated step response is too slow, opposite changes will be made.

Optionally, the tuning, simulation and switch-on can also be done manually.

The identification module 40 consists of two parts: i) a testing device and ii) a model identification device. The testing devise generates test signals, carries out the plant test automatically by writing the test signals to testing variables and collects process MV, DV and CV data. The model identification devise carries out model identification automatically using collected process data available at the moment, validate models and provide adjustment for the ongoing test. The two parts are connected seamlessly so that the whole identification procedure is done online and automatically. However, if necessary, each part can also be executed separately and manual interventional is also possible. The plant test is multivariable meaning that all MVs are excited simultaneously using test signals. The test can be in open loop when no CV is under control and in closed-loop when some CVs are under MPC or regulatory control. The online identification method is described in Zhu (2005), U.S. patent application Ser. No. 11/261,642.

The monitor module 50 monitors the performance of the MPC control as well as model quality. Four major indicators are used to monitor the MPC controller performance:
1) On/off status of MVs and CVs. When the MPC controller does not perform well, some of the MVs or CVs may be turned off by the operator or by the MPC controller itself. The on/off status of MVs and CVs will be checked continuously.
2) Oscillations of MVs and CVs. When the MPC controller performs poorly, MV and CV oscillations often exist. Oscillation detection is performed using signal spectrum analysis.
3) CV standard deviations. Immediately after the MPC controller is commissioned or maintained, the monitor module will calculate standard deviations of all CVs for a time interval called calculation period and use them as benchmarks for CV variations. The calculation period can be 24 hours or 10 times the process settling time, depends on the application. The CV standard deviations will be calculated repeatedly and compared to their benchmarks. Denote std(CVi) as the standard deviation in a calculation period for CVi and std(CVi)_{BM} as its benchmark. If ratio std(CVi)/std(CVi)_{BM} is much greater than 1, it will indicate that control performance for CVi can be poor. A threshold for the ratio is used to indicate that the control performance for the CV is very poor; the value can be 2, 3 or 5, depends on the application.
4) Model quality. The model quality for a CV is measured by the standard deviation of its simulation error. Immediately after the MPC controller is commissioned or maintained, the monitor module will calculate standard deviation of simulation errors of all CVs for the same calculation period as for the CV standard deviation calculation and use them as benchmarks for model quality. After that, standard deviations CV simulation errors will be calculated repeatedly and compared to their benchmarks. Denote std(ERRORi) as the standard deviation for simulation error of CVi and std(ERRORi)_{BM} as its benchmark. If ratio std(ERRORi)/std(ERROR)_{BM} is much greater than 1, it will indicate that model quality for CVi can be poor. A threshold for the ratio is used to indicate that the model is very poor; the value can be 2, 3 or 5, depends on the application.

The following describes how the adaptive MPC achieves automatic implementation of MPC control.

Assume that an MPC controller is designed for a given process. This implies that the lists of MVs, DVs and CVs are determined, MV and CV limits are known and control parameters are set. From process operation knowledge, the MPC user has an estimate of dominant process time to steady state (settling time) and he also determined proper sizes (amplitudes) of test signals for all MVs for plant test.

Based on process knowledge, the user has constructed a so-called Expectation Matrix. An Expectation Matrix is a matrix where columns relate to MVs and rows to CVs. The elements of the matrix contain “Strong positive gain”, or “Positive gain” or “Strong negative gain” or “Negative gain” or “Not sure” or “Empty”. A “strong positive gain” element means that a strong model with a positive gain is expected for the corresponding MV and CV; a “positive gain” element means that a normal model with positive gain is expected between the corresponding MV and CV. Similarly, a “strong negative gain” element means that a strong model with a negative gain is expected; a “negative gain” element means that a normal model with negative gain is expected. A “Not sure” element means that the user is unsure about the existence of a model for the corresponding MV and CV; “Empty” means that the user is sure that no model exists between the MV-CV pair.

All the above mentioned information is loaded in the adaptive MPC system.

Now the user can press the mouse or a computer key to start the plant test. During the test, the following tasks are performed by the identification module 40 and the control module 30:
1) The identification module excites (or step, as traditionally called) all MVs according to the test signal move patterns and their step sizes. This is shown by the arrow from the identification module 40 to the summer block before the process in FIG. 2. Usually, the sampling interval of the plant test is the same as that of the MPC controller. MV, DV and CV data are collected as shown by the three arrows to the identification module 40 in FIG. 2.
2) The identification module monitors the test and, if necessary, adjusts the test for stable operation. This is done as follows. If all CVs stay in their normal operation ranges, continue the test and do nothing. If an open loop CV drifts away slowly, change the average setpoint of some relevant MVs according to the Expectation Matrix. If a CV (either open loop or closed-loop) bumps around and hits both the high and low limits, reduce the step sizes of some relevant MVs.
3) Online automatic model identification. After about 25% of the planed test time, the identification module will start model identification using the data up to that moment and will repeat in a regular interval, e.g., when every 100 samples of new data are collected.
4) Automatic model validation and, if necessary, adjusts the test for model quality. This is done as follows. Each model is graded as A (very good), B (good), C (marginal) and D (poor or empty) using its upper error bound. Each time, the identification algorithm will calculate the model upper bounds for the current models and grade then. If certain MVs have produced enough A and B models according to the expectation matrix, their step sizes will be reduced in order to decrease disturbance to operation. In the mean time, the algorithm also calculates the future error bounds and future grades at the end of the planed test. If future grades indicate that certain expected models cannot reach A or B grades at the end of the test, the step sizes of corresponding MVs will be increased in order to increase the signal-to-noise ratios for the models. High limits are applied to step sizes of all MVs so that the plant test will not disturb process operation and they are determined using process operation knowledge.
5) After model identification, models with grades A, B and C will be loaded in the control module, provided that signs of model gains agree with that of the expectation matrix. This is shown by the dashed arrow from the identification module 40 to and cross the control module 30.
6) The control module will perform automatic simulation of a partially controlled system using the models available at the moment. If the simulation result shows a good control performance, the control module will turn on the corresponding MVs, DVs and CVs. As the plant test and model identification continues, more models will be loaded in the control module. The control module will turn on more MVs, DVs and CVs.
7) Stop the test when most, say, 80%, of expected models have reached A or B grades. The real plant test time can be shorter or longer than the planed test time. Load all models with grades A, B and C in the control module, provided that signs of model gains agree with that of the expectation matrix. The control module will simulate the control system using all the obtained models. When the simulation shows good performance, all MCs, DVs and CVs will be turned on. The MPC controller is commissioned. If necessary, after the automated commissioning, the MPC controller parameters can be fine tuned by a control expert.
8) The final model and related information are also loaded in the monitor module 50 for use in MPC performance monitoring, as shown by the dashed arrow from the identification module 40 to the monitor module 50.

Plant test is initially in open loop with none of the CVs in control. When some MVs, DVs and CVs are turned on, the test becomes (partial) closed-loop. For understanding the difference between open loop and closed-loop tests, it is useful to distinguish two parts of an MV value: 1) mean value or nominal value, the MV value without applying the test signal, 2) test signal, the perturbation added to the MV during the test. During the test, the relation is:

Full MV value=Mean value+Test signal (1)

For an MV in open loop (in off mode), the testing device will write the full MV value. When an MV is in closed-loop (in on mode), the testing device will write the test signal only, the MPC controller will write the mean value and the full MV value is obtained using a summer block; see FIG. 2. The identification method used in Zhu (2005), U.S. patent application Ser. No. 11/261,642 is able to identify process models using closed-loop data

The following describes how the adaptive MPC achieves automatic maintenance of MPC control.

The monitor module 50 is turned on when the adaptive MPC is connected to the process unit. It collects MV, DV and CD data at the MPC controller sampling time as shown by the three arrows to the monitor module 50 in FIG. 2. It continuously monitors the four performance indicators: MV and CV on/off status, oscillation, CV standard deviation and model quality. If one of the following conditions holds, the MPC maintenance can be started:
1) Some critical CVs are turned off and some critical CV model qualities are very poor for several most recent calculation periods.
2) Strong oscillation exists and some critical CV model qualities are very poor for several most recent calculation periods.
3) Some critical CV standard deviations are very large for several most recent calculation periods and some critical CV model qualities are very poor for several most recent calculation periods.

The MPC maintenance can be started in two ways. The first is that the monitor module activates the identification module; the second is that the monitor module issues a maintenance request to the user and the user decides and activates the identification module by clicking the mouse or by pressing a computer key. Then the plant test and model identification will start and the rest of MPC maintenance will follow steps 1) to 8) in the automatic MPC implementation. As the test continues and models identified, more and more models in the control module will be replaced by the new ones. The maintenance will stop when all poor models are replaced. Note that the plant test in MPC maintenance is mostly closed-loop test with the existing MPC controller still turned on. Although the existing MPC controller does not perform as well as before, it is most often still better than open loop manual control.

For a strongly nonlinear process unit, multiple models will be identified using the identification module. Each model is a linear model or a simple nonlinear model such as Wiener model and Hammerstein model. A Wiener model consists of dynamic linear block followed by a static nonlinear block; a Hammerstein model consists of a static nonlinear block followed by a dynamic linear block.

The control module will use multiple models to control the process unit. At a control interval, one model is used in the control module for prediction and control calculation. The model that best fit the process behaviour at that moment is selected used. There are two ways in selecting the best control model: 1) switching method and 2) interpolation method. Model selection is done automatically.

In switching method all available models are simulated using the most recent MV, DV and CV data and the simulated CVs and measured CVs are compared. A model is selected if its simulation error is minimal.

In interpolation method, a so-called working point variable is used to indicate where the process is operating. A working point variable is a process variable or a function of process variables. Examples of working point variables are grade indexes of polymer units and lubricate oil units, and load of a power plant. Assume that multiple models are identified at multiple working points. At a control interval, if the current working point has an identified model, then the model is selected and used in the control module; if the current does not have an identified model, then a linear interpolation of the two neighbour models will be determined and used in the control module. If the current working point is outside the model range, then the model of the closest working point will be used.

### CITED LITERATURE

Qin, S. J. and T. A. Badgwell (2003). A survey of industrial model predictive control technology, Control Engineering Practice, Vol. 11, pp. 733-764.
Richalet, J. (1993). Industrial applications of model based predictive control. Automatica, Vol. 29, No. 5, pp. 1251-1274.
Zhu, Y. C. (2005). Computer method and apparatus for online process identification. U.S. patent application Ser. No. 11/261,642.

1. Computer method and apparatus for adaptive model predictive control (MPC) system compromising: an MPC control module, an online identification module and a control monitor module.

2. Computer method and apparatus as claimed in claims 1 where the three modules work together to perform automatic implementation of new MPC controllers, and, for an existing MPC controller, to perform automatic maintenance.

3. Computer method and apparatus as claimed in claim 1 wherein the control module can perform automated simulation.

4. Computer method and apparatus as claimed in claims 1 wherein the control module can perform automated control tuning to improve simulated control performance.

5. Computer method and apparatus as claimed in claim 1 wherein the control module can automatically switch MVs, DVs and CVs on when simulated control performance is satisfactory.

6. Computer method and apparatus as claimed in claim 1 wherein the control module can use multiple models in prediction and control calculation.

7. Computer apparatus as claimed in claim 1 wherein the identification module uses automatic multivariable and closed-loop test and online model identification.

8. Computer apparatus as claimed in claim 1 wherein identification module identifies multiple models for strongly nonlinear processes.

9. Computer apparatus as claimed in claim 1 wherein identification module uses automated model validation and sends good models to control module for use in MPC control.

10. Computer apparatus as claimed in claim 1 wherein the monitor module monitors the performance of the MPC controller and the quality of the process model.

11. Computer apparatus as claimed in claim 1 wherein, when the monitor module determines that the MPC control performance is poor and model quality is low, it can start the MPC maintenance by activating the identification module.

12. Computer apparatus as claimed in claim 1 wherein, when activated by the monitor module, the identification module can re-identify process models and load them in the control module, which achieves MPC controller maintenance.
